(19) United States
(12) Patent Application Publication
(10) Pub. No.: US 2025/0083878 A1
(43) Pub. Date: Mar. 13, 2025

(54) INTERACTIVE CAN

(71) Applicant: Matthew Tyson, Brooklyn, NY (US)

(72) Inventor: Matthew Tyson, Brooklyn, NY (US)

(21) Appl. No.: 18/826,186

(22) Filed: Sep. 6, 2024

Related U.S. Application Data
(60) Provisional application No. 63/536,943, filed on Sep. 7, 2023.

(51) Int. Cl. B65D 51/24; G09F 23/00

(52) U.S. Cl. CPC B65D 51/245; G09F 23/0091; B65D 2203/02

(57) ABSTRACT

An interactive can includes a can top surface with displayed markings such as letters, numbers, words, or graphical elements; and a rotatable tab comprising an indicator for selecting at least one of the markings. The indicator may be an opening in the tab, such as a finger hole, which can be used to frame a selected marking. The tab may be rotated to select a marking and the selected marking may then be shown to one or more others as a message or game.

### CROSS-REFERENCE TO RELATED APPLICATIONS

The present application claims priority under 35 USC 119(e) to U.S. Provisional Application No. 63/536,943 filed on Sep. 7, 2023, the entire contents of which is incorporated by reference.

### FIELD OF THE INVENTION

The present invention generally relates to beverage cans. Specifically, the present invention relates to an interactive beverage can.

### BACKGROUND

Traditionally, can tabs have served the simple purpose of opening an aluminum can top to gain access to the liquid contents inside. A user simply lifts on the ring portion of the tab and lifts away a portion of the can top designed to tear away from the rest of the aluminum can top. In general, the tab serves no other purpose than opening the can. The can top and tab therefore represent an unutilized or underutilized area of the can that could be used for other purposes besides just opening the can.

### BRIEF SUMMARY

An interactive can, such as a beer or soda can, includes a top surface with displayed markings and a rotatable pull tab. The markings might include graphics, text or other indicia displayed conspicuously on the can top surface. The pull tab includes an indicator that a user can position to indicate at least one of the markings by rotating the tab to indicate the selected marking. In one embodiment, the pull tab ring serves as the indicator and can be used to frame one or more of the markings. The indicated marking can then be displayed to one or more other people as a message or as part of a game.

The displayed markings on the can may be physical markings or augmented reality (AR) or virtual reality (VR) generated digital markings visible on the can through a VR/AR enabled headset or glasses. Although the pull tab may include or act as a physical indicator, the indicator may also be an AR/VR generated indicator that can appear anywhere on the can and perform the same function as the physical (e.g., pull tab indicator) described above.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A illustrates a top plan view of the interactive can in accordance with one embodiment.

FIG. 1B illustrates a top plan view of the interactive can in accordance with one embodiment.

FIG. 1C illustrates a top plan view of the interactive can in accordance with one embodiment.

FIG. 1D illustrates a top plan view of the interactive can in accordance with one embodiment.

FIG. 1E illustrates a top plan view of the interactive can in accordance with one embodiment.

FIG. 1F illustrates a top plan view of the interactive can in accordance with one embodiment.

FIG. 1G illustrates a top plan view of the interactive can in accordance with one embodiment.

FIG. 1H illustrates a top plan view of the interactive can in accordance with one embodiment.

FIG. 1I illustrates a top plan view of the interactive can in accordance with one embodiment.

FIG. 1J illustrates a top plan view of the interactive can in accordance with one embodiment.

FIG. 1K illustrates a top plan view of the interactive can in accordance with one embodiment.

FIG. 1L illustrates a top plan view of the interactive can in accordance with one embodiment.

FIG. 1M illustrates a top plan view of the interactive can in accordance with one embodiment.

FIG. 1N illustrates a top plan view of the interactive can in accordance with one embodiment.

FIG. 1O illustrates a top plan view of the interactive can in accordance with one embodiment.

FIG. 2 illustrates a perspective view of an interactive can in accordance with one embodiment.

FIG. 3 illustrates a close-up perspective view of the interactive can of FIG. 2.

### DETAILED DESCRIPTION

Description will now be given of the invention with reference to the attached figures. It should be understood that these figures are exemplary in nature and in no way serve to limit the scope of the invention as the invention will be defined by the claims.

An interactive can includes a can top surface with displayed markings and a rotatable pull tab for indicating at least one of the markings. The markings are displayed conspicuously on the can top surface and can include graphics, text, or other indicia. A user can select at least one of the markings by rotating the pull tab to a desired position that indicates the selected marking. The user can then show the selected marking to one or more other people in order to communicate a message or play a game. In one embodiment, the ring portion of the pull tab serves as the indicator and is used to frame at least one of the markings.

The markings are positioned on the can top in such a way that the user can position the pull tab to clearly indicate a selected marking. For example, the user can rotate the pull tab until the selected marking is framed within the ring portion of the pull tab.

According to one exemplary embodiment, the markings include a plurality of icons such as emojis. The user can then rotate the tab until one of the emojis is framed within the ring portion of the pull tab. The user can then show the can top with selected emoji to a friend to express his current emotional state. In other embodiments, the indicator is a pointer such as an arrow displayed on the tab and can be used to point to at least one of the markings. For example, the pointer could be shaped like a finger or an arrow to clearly indicate a selected marking. One of ordinary skill in the art will appreciate that any type of graphic may be displayed on the tab as an indicator.

As discussed above, the ring portion of the tab could be used as an indicator, but many other indicators are possible. For example, instead of a ring the tab could include a rectangular, triangular, circular, or any other shaped opening to accommodate a user's finger in opening the can and to frame a selected marking. Alternatively, the tab need not include an opening for inserting a finger, but rather may be a continuous tab with no opening. Instead of an opening the tab could include a translucent or semitransparent window for displaying a selecting marking inside the window. Such a continuous tab could still be used to open the can by simply lifting up on the tab, so there is no need for a finger hole.

The displayed markings can also include text such as letters of the alphabet, numbers, roman numerals, words, dates, times, or other indicia. In one embodiment, the text includes words describing a state of inebriation such as sober, buzzed, drunk, wasted, etc. The user can then rotate the tab to select one of the words using the indicator and show the selection to a friend. The can top thus becomes a communication device to express the user's current state. In another embodiment, the markings could include possible outcomes in a game such as baseball. For example, words such as single, double, triple, and home run could be displayed on the can top. The user can then move the tab until the indicator is directed to a selected outcome (e.g., home run) the user is predicting. In other embodiment, words or symbols associated with a game such as rock, paper, scissors can be displayed on the can top and two users each having interactive can may select a word/symbol as part of playing the game. One of ordinary skill in the art will appreciate that many different types of words or symbols can be displayed on the can top such as game outcomes, words associated with a game, names, places, dates, emotional states, actions, or any other types of words.

Two or more people holding interactive cans may communicate or play games using their respective can tops. For example, each person can take turns selecting a marking such as a word and display it to the other(s). This form of communication can be very useful at a loud game or concert where it may be difficult to hear someone talking. In addition, the indicator and/or markings may include a glow-in-the-dark material to make it easier for users to see selected markings in a dark environment. For example, the tab may be glow-in-the-dark, or just the outline of the tab opening may be glow-in-the-dark. Also, in the embodiment with the translucent or semi-transparent window the window may include translucent night vision material to help see the selected marking in a dark environment.

The markings may be laser etched, printed, or stamped onto the can top. One of ordinary skill in the art will recognize that there are many ways to display the markings on the can top and any described method of imprinting the markings should be considered nonlimiting. In addition, the markings may be displayed in any color or no color and may include braille or other tactile indicia to help visually impaired individuals identify and select a marking.

According to an embodiment of the present invention, a method of using an interactive can to display a message includes rotating a tab comprising an indicator to a position in which the indicator is directed to at least one of a plurality of markings on a surface of the can top; and displaying the indicated marking to another person. As discussed above, the indicator can be a pointer displayed on the tab, or an outline of a tab ring or other shaped tab opening which may be used to frame a selected marking. A user can then move the tab to another position to indicate a different marking and display the indicated different marking to the other person as part of an ongoing communication or game.

In another embodiment, the markings are augmented reality (AR) or virtual reality (VR) generated markings that appear on the can, for example, on the can top surface. The markings are visible through use of an AR/VR enabled headset or glasses. In addition, the indicator may be an AR/VR generated indicator. In the case of AR generated markings and/or an AR indicator, the AR images (e.g., markings and/or indicator) may be static, moving, or interactive images that appear on the physical can. For example, an interactive spinner displayed on top of the can may be used to play a game like “spin the bottle” as discussed above. Other images may be computer-generated representations of the markings discussed above and may appear on the top surface, side wall or any other part of the can. A physical or computer-generated indicator on the can may then be manipulated by a user to select a marking appearing on the can. For example, the indicator may be used to select, align with, or highlight a marking, such as a graphic, as part of a game, or to communicate with another person or third-party vendor (e.g., place an order for food or beverage).

In the case of VR, the entire can along with the markings and indicator may be virtual, i.e., computer generated. For example, a user wearing a VR headset at an event or elsewhere may be presented with one or more virtual cans as a reminder to purchase a beverage. The user can interact with the virtual can in the same way as interacting with the physical can described throughout this application, e.g., selecting a marking as part of a game, communication, opening a website or app, etc. The VR can also be opened by pulling the virtual tab which may trigger an event such as placing an order with a vendor, revealing a secret message, starting an audio-visual presentation, starting a game, or opening another website or app.

According to another embodiment, a quick response (QR) code or other identifier (e.g., image, barcode, text, etc.) may be printed on the can. The code or identifier may then be scanned by a user's smart phone or other scanning device to open a website or app, i.e., the code may serve as a link to open a website or app. The app could be used for anything such as keeping score at a game, dating, or playing game such as rock-paper-scissors.

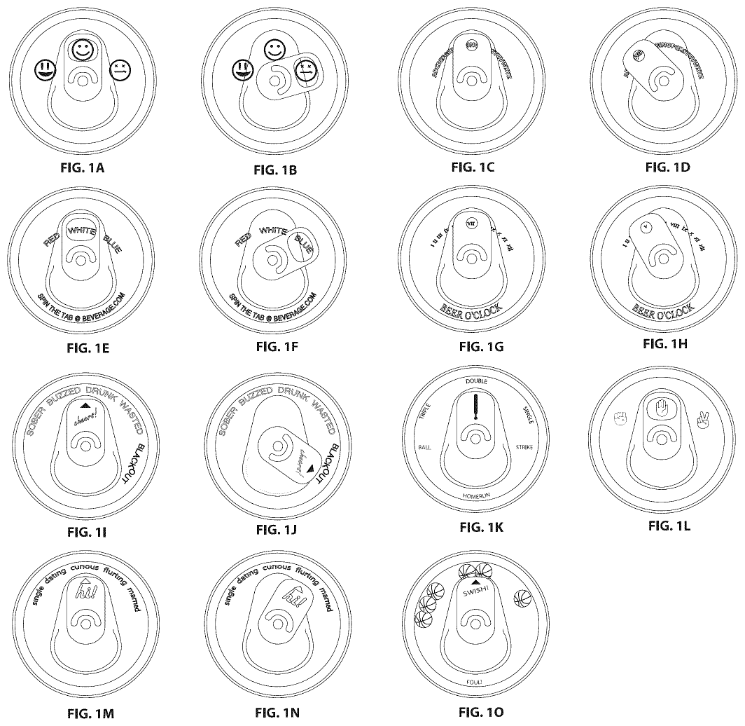

Turning to FIGS. 1A-O, various embodiments of can tops are illustrated. FIG. 1A shows different emojis displayed on the can top surface. The tab is positioned to select the middle emoji by framing the emoji inside the ring portion of the tab. This position can be considered the default position of the tab before it is rotated. FIG. 1B shows the tab of FIG. 1A rotated to select the emoji on the right.

FIG. 1C shows an embodiment in which the tab includes a small circular opening more suitable for framing one or more letters of the alphabet as illustrated in the figure. FIG. 1D shows the tab of FIG. 1C rotated to select a different letter on the left side. As can be seen the letters are printed in an arc shape so that the circular opening of tab aligns with the letters as the tab is rotated.

FIG. 1E shows an embodiment in which words are displayed on the can top, in this case “RED”, “WHITE” and “BLUE.” The tab is positioned to select the middle word (i.e., “WHITE”) and this position can be considered the default position of the tab before it is rotated. FIG. 1F shows the tab of FIG. 1E rotated to select the word “BLUE.”

FIG. 1G shows an embodiment in which roman numerals representing time are displayed on the can top. The tab is positioned to select the numeral VII in the middle and this position can be considered the default position of the tab before it is rotated. FIG. 1H shows the tab of FIG. 1G rotated to select numeral V. The words “BEER O'CLOCK” are displayed on the bottom.

FIG. 1I shows an embodiment in which states of inebriations are displayed on the can top. The tab includes an arrow indicator displayed on the tab which points to the “DRUNK”.” This position can be considered the default position of the tab before it is rotated. FIG. 1J shows the tab of FIG. 1I rotated to select the word “BLACKOUT.” The word “Cheers!” is displayed on the tab below the arrow.

FIG. 1K shows an embodiment in which outcomes in a baseball game are displayed on the can top, such as “SINGLE,” “DOUBLE,” “TRIPLE,” “HOME RUN,” “BALL,” and “STRIKE.” According to the figure, the indicator is a baseball bat displayed on the tab. FIG. 1K shows the bat pointed to a “DOUBLE” which may indicate that the user expects the next hit in the game to be a double.

FIG. 1L shows an embodiment in which hand signal icons are displayed on the can top. The tab is positioned to select the middle hand signal and this position can be considered the default position of the tab before it is rotated.

FIG. 1M shows an embodiment in which a dating status is displayed on the can top. According to the figure, an arrow indicator on the tab is pointed at “CURIOUS.” FIG. 1N shows the tab of FIG. 1M rotated to select “FLIRTING.” The words “hi!” is displayed on the tab, under the arrow.

FIG. 1O shows an embodiment in which basketballs representing foul shots are displayed on the can top. According to the figure, an arrow indicator on the tab is pointed at two basketballs which indicates that the user may be expecting two foul shots. The word “SWISH!” is displayed on the tab, under the arrow.

According to another embodiment, the interactive can may be used in concert with an online application such as game. For example, an online game like “spin the bottle” residing on a user's mobile device may be paired with a sensor attached to the tab. When the tab is tapped or rotated, such action will cause a virtual bottle in the online application to spin. When the virtual bottle comes to rest it will indicate another player's name, image or likeness who may be in close proximity or remote to the user. A romantic gesture such as a virtual kiss may then be directed to the indicated individual. A person of ordinary skill in the art will appreciate that there are other online applications besides such games that may be used in concert with the interactive can.

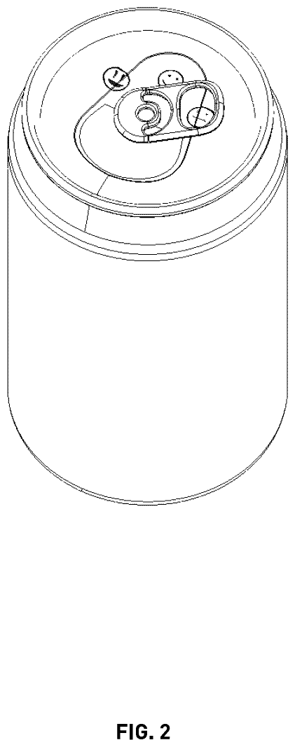

FIG. 2 illustrates an embodiment in which three emojis are displayed on the can top surface of the interactive can. The tab has been rotated to select the emoji on the right side by framing the selected emoji inside the tab ring or finger hole.

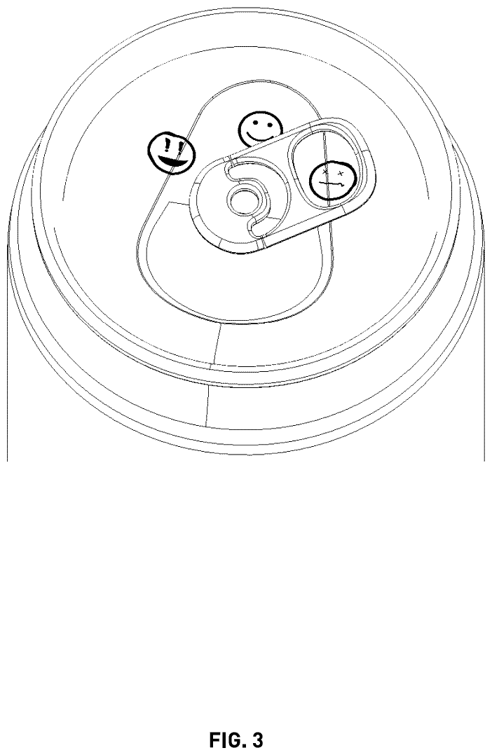

FIG. 3 is a close-up view of the interactive can top surface of FIG. 2.

It will be understood by those of ordinary skill in the art that various changes may be made and equivalents may be substituted for elements without departing from the scope of the invention. In addition, many modifications may be made to adapt a particular feature or material to the teachings of the invention without departing from the scope thereof. Therefore, it is intended that the invention not be limited to the particular embodiments disclosed, but that the invention will include all embodiments falling within the scope of the claims.

What is claimed is:

1. An interactive can comprising:
a can top surface with displayed markings; and
a rotatable tab comprising an indicator for indicating at least one of the markings.

2. The interactive can of claim 1, wherein the markings comprise a plurality of selectable symbols or icons.

3. The interactive can of claim 1, wherein the markings comprise text.

4. The interactive can of claim 1, wherein the ring portion of the tab serves as the indicator.

5. The interactive can of claim 1, wherein the indicator frames at least one of the markings.

6. The interactive can of claim 1, wherein the indicator points to at least one of the markings.

7. The interactive can of claim 1, wherein the markings are etched on the can top surface.

8. The interactive can of claim 1, wherein the markings are printed on the can top surface.

9. The interactive can of claim 1, wherein the markings are stamped on the can top surface.

10. A method of using an interactive can to display a message, the method comprising:
rotating a tab comprising an indicator to a position in which the indicator is directed to at least one of a plurality of markings on a surface of the can top; and
displaying the indicated marking to another person.

11. The method of claim 10, further comprising:
rotating the tab to another position to indicate a different marking; and
displaying the indicated different marking.
